(19) United States
(12) Patent Application Publication
(10) Pub. No.: US 2026/0331038 A1
(43) Pub. Date: Oct. 22, 2026

(54) PIXEL CIRCUIT, DRIVING METHOD THEREOF, AND DISPLAY PANEL

(71) Applicant: Beijing Visionox Technology Co., Ltd., Beijing (CN)

(72) Inventors: Cuili GAI, Beijing (CN); Lei MI, Beijing (CN); Enqing GUO, Beijing (CN); Long CHEN, Beijing (CN)

(73) Assignee: Beijing Visionox Technology Co., Ltd., Beijing (CN)

(21) Appl. No.: 19/694,988

(22) Filed: Jun. 2, 2026

(30) Foreign Application Priority Data
Jun. 12, 2025 (CN) 202510788174.7

(51) Int. Cl. G09G 3/32

(52) U.S. Cl. CPC G09G 3/32; G09G 2300/043; G09G 2300/0819; G09G 2300/0852; G09G 2310/08; G09G 2320/0233; G09G 2320/0247; G09G 2320/045

(57) ABSTRACT

The embodiments of the present application disclose a pixel circuit, a driving method for the pixel circuit, and a display panel. The pixel circuit includes a driving module, a data writing module, a coupling module, a compensation module, and a light-emitting module. The data writing module is configured to write a data voltage of a current frame into an internal node of the data writing module during a light emission phase of a previous frame, and write the data voltage of the current frame on the internal node to the first terminal of the coupling module during a data writing phase of the current frame, and the coupling module is configured to write a voltage associated with the data voltage of the current frame to the control terminal of the driving module. The compensation module is configured to compensate a threshold voltage of the driving module during a compensation phase.

### CROSS-REFERENCE TO RELATED APPLICATIONS

This application claims priority to Chinese Patent Application No. 202510788174.7, filed on Jun. 12, 2025, entitled "Pixel Circuit, Driving Method Thereof, and Display Panel", which is incorporated herein by reference in its entirety.

### FIELD

The embodiments of the present application relate to the field of display technology, and particularly to a pixel circuit, a driving method thereof, and a display panel.

### BACKGROUND

With the rapid development of display technology, display requirements for a display panel are increasingly demanding.

Currently, a display panel in related technologies has a problem of poor display quality and cannot meet customer needs.

### SUMMARY

Embodiments of the present application provide a pixel circuit, a driving method thereof, and a display panel, to improve a display effect.

According to an aspect of the present application, a pixel circuit is provided, including:
a driving module, a data writing module, a coupling module, a compensation module, and a light-emitting module;
the data writing module is connected to a first terminal of the coupling module, a second terminal of the coupling module is connected to a control terminal of the driving module, the data writing module is configured to write a data voltage of a current frame into an internal node of the data writing module during a light emission phase of a previous frame, and write the data voltage of the current frame on the internal node to the first terminal of the coupling module during a data writing phase of the current frame, and the coupling module is configured to write a voltage associated with the data voltage of the current frame to the control terminal of the driving module;
the compensation module is connected between a first terminal and the control terminal of the driving module, and the compensation module is configured to compensate a threshold voltage of the driving module during a compensation phase;
the driving module and the light-emitting module are connected between a first power supply line and a second power supply line, and the driving module is configured to drive the light-emitting module to emit light during a light emission phase;
within one frame, the compensation phase is before the data writing phase.

According to another aspect of the present application, a driving method for a pixel circuit is provided, the pixel circuit includes a driving module, a data writing module, a coupling module, a compensation module, and a light-emitting module;
the driving method for the pixel circuit includes:
   in a first writing phase, controlling the data writing module to write a data voltage of a current frame to an internal node of the data writing module;
   in a compensation phase, controlling the compensation module to compensate a threshold voltage of the driving module;
   in a second writing phase, controlling the data writing module to transmit the data voltage of the current frame on the internal node of the data writing module to a first terminal of the coupling module, and controlling the coupling module to write voltage information associated with the data voltage of the current frame to a control terminal of the driving module;
   in a light emission phase, controlling the driving module to drive the light-emitting module to emit light;
   in one embodiment, the first writing phase is a light emission phase of a previous frame, and the second writing phase is a data writing phase of the current frame.

According to another aspect of the present application, a display panel is provided, the display panel includes the pixel circuit provided by any embodiment of the present application;
the display panel further includes a plurality of scan signal lines, a plurality of first control signal lines, a plurality of second control signal lines, a plurality of third control signal lines, a plurality of fourth control signal lines, and a plurality of fifth control signal lines, the pixel circuit further includes a first initialization module, a second initialization module, and a light emission control module, the first initialization module is connected between a second voltage signal line and a first terminal of a coupling module, the second initialization module is connected between a third voltage signal line and a control terminal of a driving module, the light emission control module is connected between a first terminal of the driving module and a first terminal of a light-emitting module; a data writing module includes a first switching unit, a second switching unit, and a first storage unit, a first terminal of the first switching unit is connected to a data line, a second terminal of the first switching unit and a first terminal of the second switching unit are connected to a first node, a second terminal of the second switching unit is connected to the first terminal of the coupling module, a first terminal of the first storage unit is connected to a first voltage signal line, and a second terminal of the first storage unit is connected to the first node;
in one embodiment, each row of the pixel circuits is respectively connected to one of the scan signal lines, one of the first control signal lines, one of the second control signal lines, one of the third control signal lines, one of the fourth control signal lines, and one of the fifth control signal lines, the plurality of scan signal lines are configured to transmit a scan signal to the first switching unit of the pixel circuit row by row, the plurality of first control signal lines are configured to simultaneously transmit a first control signal to the light emission control module of the pixel circuit of all rows, the plurality of second control signal lines are configured to simultaneously transmit a second control signal to a compensation module of the pixel circuit of all rows, the plurality of third control signal lines are configured to simultaneously transmit a third control signal to the second switching unit of the pixel circuit of all rows, the plurality of fourth control signal lines are configured to simultaneously transmit a fourth control signal to the first initialization module of the pixel circuit of all rows, and the plurality of fifth control signal lines are configured to simultaneously transmit a fifth control signal to the second initialization module of the pixel circuit of all rows.

An embodiment provided by an embodiment of the present application, by writing a data voltage of a current frame to an internal node of a data writing module during a light emission phase of a previous frame, and transmitting the data voltage of the current frame on the internal node to a first terminal of a coupling module during a data writing phase of the current frame, utilizes time of a light emission period for data writing, which is beneficial to reducing data writing time within one frame, thereby facilitating shortening a row time to achieve a high refresh rate display. In addition, by adopting a coupling method to transmit the data voltage to a control terminal of a driving module, a threshold voltage compensation of the driving module is performed separately from the data writing, and the threshold voltage compensation is performed before writing the data voltage to the control terminal of the driving module, and a compensation phase and the data writing phase do not affect each other, thereby making time of the threshold voltage compensation unaffected by the data writing phase. Under a high refresh rate, a threshold voltage of the driving module can be completely compensated, thereby reducing a difference in characteristics of driving modules corresponding to different pixels, which is beneficial to improving a difference in display brightness and enhancing uniformity of display quality.

### BRIEF DESCRIPTION OF THE DRAWINGS

To more clearly illustrate an embodiment of the present application, a drawing required for use in a description of the embodiment will be briefly introduced below. In one embodiment, the drawing described below is some embodiments of the present application.

FIG. 1 is a structural schematic diagram of a pixel circuit provided by an embodiment of the present application;

FIG. 2 is a structural schematic diagram of another pixel circuit provided by an embodiment of the present application;

FIG. 3 is a structural schematic diagram of another pixel circuit provided by an embodiment of the present application;

FIG. 4 is a structural schematic diagram of another pixel circuit provided by an embodiment of the present application;

FIG. 5 is a driving timing schematic diagram of a pixel circuit provided by an embodiment of the present application;

FIG. 6 is a structural schematic diagram of another pixel circuit provided by an embodiment of the present application;

FIG. 7 is a structural schematic diagram of another pixel circuit provided by an embodiment of the present application;

FIG. 8 is a structural schematic diagram of another pixel circuit provided by an embodiment of the present application;

FIG. 9 is a flowchart of a driving method for a pixel circuit provided by an embodiment of the present application;

FIG. 10 is a flowchart of another driving method for a pixel circuit provided by an embodiment of the present application;

FIG. 11 is a structural schematic diagram of a display panel provided by an embodiment of the present application.

### DETAILED DESCRIPTION

To enable a person to better understand a solution of the present application, an embodiment of the present application will be clearly and completely described below in conjunction with a drawing in the embodiment of the present application. In one embodiment, the described embodiment is only some embodiments of the present application, not all of the embodiments.

Terms "first", "second", etc. in a specification and claims of the present application and the above drawings are used to distinguish similar objects, and are not necessarily used to describe a specific order or sequence. Data used, in one embodiment, may be interchangeable under appropriate circumstances, and the embodiment of the present application described herein can be implemented in an order other than those illustrated or described herein. In addition, terms "comprising" and "having" and any variations thereof are intended to cover a non-exclusive inclusion. For example, a process, a method, a system, a product, or a device that includes a series of steps or units is not necessarily limited to those clearly listed steps or units, but may include another step or unit that is not clearly listed or is inherent to these processes, methods, products, or devices.

FIG. 1 is a structural schematic diagram of a pixel circuit provided by an embodiment of the present application. Referring to FIG. 1, the pixel circuit provided by the present embodiment includes a driving module 110, a data writing module 120, a coupling module 130, a compensation module 140, and a light-emitting module 150. The data writing module 120 is connected to a first terminal of the coupling module 130, and a second terminal of the coupling module 130 is connected to a control terminal of the driving module 110. The data writing module 120 is configured to write a data voltage Vdata of a current frame into an internal node of the data writing module 120 during a light emission phase of a previous frame, and write the data voltage Vdata of the current frame on the internal node to the first terminal of the coupling module 130 during a data writing phase of the current frame. The coupling module 130 is configured to write a voltage associated with the data voltage Vdata of the current frame to the control terminal of the driving module 110. The compensation module 140 is connected between a first terminal and the control terminal of the driving module 110, and the compensation module 140 is configured to compensate a threshold voltage of the driving module 110 during a compensation phase. The driving module 110 and the light-emitting module 150 are connected between a first power supply line L1 and a second power supply line L2, and the driving module 110 is configured to drive the light-emitting module 150 to emit light during a light emission phase. Within one frame, the compensation phase is before the data writing phase.

In one embodiment, during an operation of the pixel circuit, the data voltage Vdata is first written to the internal node of the data writing module 120 during the light emission phase of the previous frame. When the current frame arrives, a voltage on the internal node is written to the first terminal of the coupling module 130 during the data writing phase. The coupling module 130 couples a voltage variation of the first terminal to the second terminal, that is, couples the voltage variation to the control terminal of the driving module 110, and a voltage at the control terminal of the driving module 110 is associated with the data voltage Vdata of the current frame.

Due to a presence of the coupling module 130, a threshold voltage compensation process of the driving module 110 can be performed separately from the data writing phase. For example, in the compensation phase, the control terminal of the driving module 110 is charged through a first power supply voltage VDD transmitted on the first power supply line L1 to achieve a compensation of the threshold voltage of the driving module 110.

The compensation phase is before the data writing phase. After the data voltage Vdata of the current frame is written to the control terminal of the driving module 110, the driving module 110 generates a driving current according to the voltage at the control terminal to drive the light-emitting module 150 to emit light.

An embodiment provided by the embodiment of the present application, by writing the data voltage Vdata of the current frame to the internal node of the data writing module 120 during the light emission phase of the previous frame, and transmitting the data voltage Vdata of the current frame on the internal node to the first terminal of the coupling module 130 during the data writing phase of the current frame, utilizes time of a light emission period for data writing, which is beneficial to reducing data writing time within one frame, thereby facilitating shortening a row time to achieve a high refresh rate display. In addition, by adopting a coupling method to transmit the data voltage Vdata to the control terminal of the driving module 110, the threshold voltage compensation of the driving module 110 is performed separately from the data writing, and the threshold voltage compensation is performed before writing the data voltage Vdata to the control terminal of the driving module 110, and the compensation phase and the data writing phase do not affect each other, thereby making time of the threshold voltage compensation unaffected by the data writing phase. Under a high refresh rate, the threshold voltage of the driving module 110 can be completely compensated, thereby reducing a difference in characteristics of driving modules 110 corresponding to different pixels, which is beneficial to improving a difference in display brightness and enhancing uniformity of display quality.

Continuing to refer to FIG. 1, the pixel circuit provided by the present embodiment further includes a light emission control module 160. A first terminal of the light emission control module 160 is connected to the first terminal of the driving module 110, a second terminal of the light emission control module 160 is connected to a first terminal of the light-emitting module 150, a second terminal of the light-emitting module 150 is connected to the second power supply line L2, and the first terminal of the driving module 110 is connected to the first power supply line L1.

In one embodiment, a first power supply voltage VDD transmitted on the first power supply line L1 and a second power supply voltage VSS transmitted on the second power supply line L2 are both a constant voltage, and the first power supply voltage VDD may be a positive voltage, and the second power supply voltage VSS may be a negative voltage. In a non-light emission phase, the light emission control module 160 is controlled to be turned off to prevent the first power supply voltage VDD from being transmitted to the first terminal of the light-emitting module 150, thereby preventing the light-emitting module 150 from emitting light in the non-light emission phase.

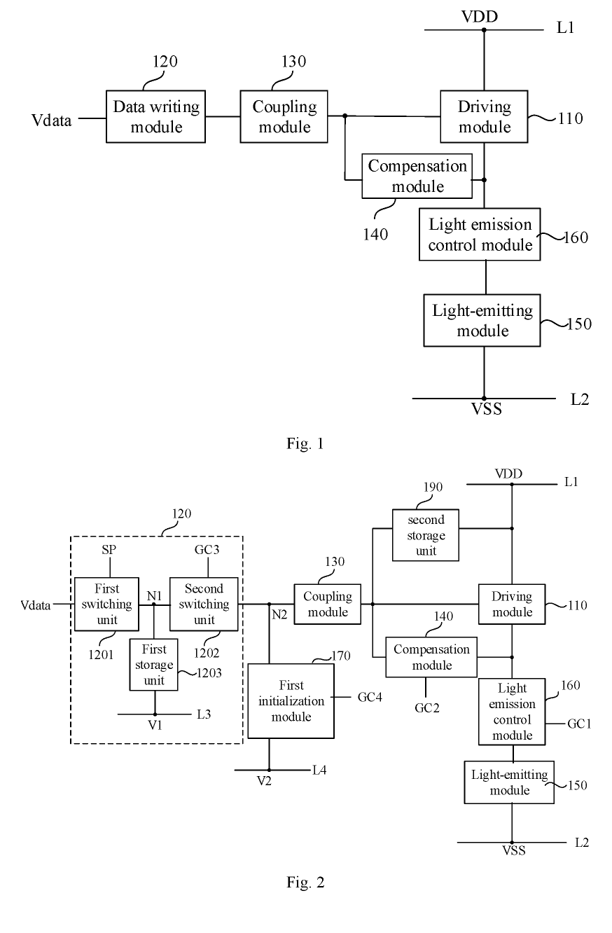

FIG. 2 is a structural schematic diagram of another pixel circuit provided by an embodiment of the present application. Referring to FIG. 2, the data writing module 120 includes a first switching unit 1201, a second switching unit 1202, and a first storage unit 1203. A first terminal of the first switching unit 1201 is connected to a data line, a second terminal of the first switching unit 1201 and a first terminal of the second switching unit 1202 are connected to a first node N1, a second terminal of the second switching unit 1202 is connected to the first terminal of the coupling module 130, and a control terminal of the first switching unit 1201 is connected to a scan signal line to receive a scan signal SP transmitted on the scan signal line. A control terminal of the second switching unit 1202 is connected to a third control signal line to receive a third control signal GC3 transmitted on the third control signal line. The first switching unit 1201 is configured to write the data voltage Vdata of the current frame to the first node N1 during the light emission phase of the previous frame. The second switching unit 1202 is configured to write the data voltage Vdata of the current frame on the first node N1 to the first terminal of the coupling module 130. A first terminal of the first storage unit 1203 is connected to a first voltage signal line L3, a second terminal of the first storage unit 1203 is connected to the first node N1 to store a voltage of the first node N1, and the first voltage signal line L3 may transmit a first voltage V1.

A control terminal of the light emission control module 160 is connected to a first control signal line to receive a first control signal GC1 transmitted on the first control signal line. A control terminal of the compensation module 140 is connected to a second control signal line to receive a second control signal on the second control signal line.

In one embodiment, during the light emission phase of the previous frame, such as a light emission phase of an (n-1)th frame, the first switching unit 1201 is controlled to be turned on in response to the scan signal SP, the second switching unit 1202 is controlled to be turned off in response to the third control signal GC3, and a data voltage Vdata of an nth frame transmitted on the data line is written to the first node N1 and stored on the first storage unit 1203. When the current frame (i.e., the nth frame) arrives, during the data writing phase, the first switching unit 1201 is controlled to be turned off in response to the scan signal SP, the second switching unit 1202 is controlled to be turned on in response to the third control signal GC3, and the data voltage Vdata of the current frame stored on the first storage unit 1203 is transmitted to the first terminal of the coupling module 130 through the second switching unit 1202. The coupling module 130 couples the voltage variation of the first terminal to the control terminal of the driving module 110, thereby achieving a data writing. During a light emission phase (the light emission phase of the nth frame), the driving module 110 is controlled to drive the light-emitting module 150 to emit light, while a data voltage Vdata of an (n+1)th frame is written to the first node N1. In one embodiment, n is an integer greater than 1.

In the present embodiment, the data voltage Vdata is written in two times in total. A first writing is during the light emission phase of the previous frame, through the first switching unit 1201, a data voltage Vdata of a next frame is written to the first node N1. A second writing is during the data writing phase of the current frame, the data voltage Vdata of the current frame stored on the first node N1 in the previous frame is written to the first terminal of the coupling module 130. During the light emission phase of the current frame, the data line transmits a data voltage Vdata corresponding to a next frame, and the data voltage Vdata is stored on the first storage unit 1203 for use in the next frame. Since a light emission process of the light-emitting module 150 does not affect a writing process of the data voltage Vdata, the data voltage Vdata of the current frame can be written during the light emission phase of the previous frame, and the data voltage Vdata is directly written to the control terminal of the driving module 110 through the coupling module 130 in the current frame. Compared with a traditional way of writing the data voltage through the compensation module, the present solution can shorten the data writing time, thereby facilitating an improvement of a refresh rate.

In one embodiment, the pixel circuit further includes a first initialization module 170. A first terminal of the first initialization module 170 is connected to a second voltage signal line L4, and a second terminal of the first initialization module 170 is connected to the first terminal of the coupling module 130, that is, the data writing module 120, the coupling module 130, and the first initialization module 170 are connected to a second node N2. A control terminal of the first initialization module 170 is connected to a fourth control signal line to receive a fourth control signal GC4 transmitted on the fourth control signal line. The first initialization module 170 is configured to transmit a second voltage V2 on the second voltage signal line L4 to the first terminal of the coupling module 130 during an initialization phase and the compensation phase.

The initialization phase is before the compensation phase. During the initialization phase, the first initialization module 170 is turned on in response to the fourth control signal GC4 to transmit the second voltage V2 to the second node N2, to initialize a potential of the second node N2. During the compensation phase, the first initialization module 170 remains turned on to clamp a voltage of the second node N2, and the compensation module 140 can perform the threshold voltage compensation on the control terminal of the driving module 110.

In one embodiment, continuing to refer to FIG. 2, the pixel circuit further includes a second storage unit 190. The second storage unit 190 is connected between a second terminal and the control terminal of the driving module 110, and the second storage unit 190 is configured to store the voltage at the control terminal of the driving module 110.

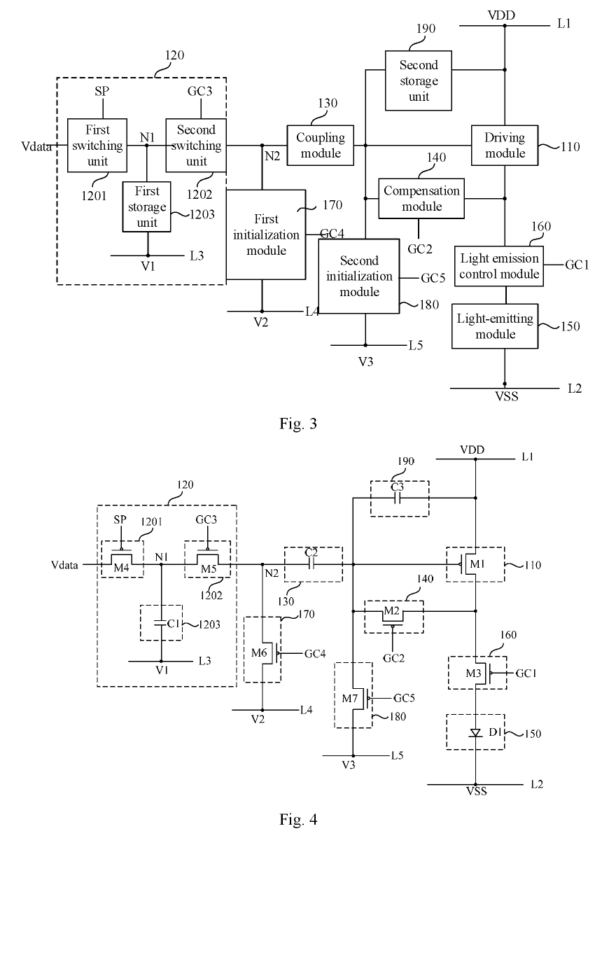

FIG. 3 is a structural schematic diagram of another pixel circuit provided by an embodiment of the present application. Referring to FIG. 3, on a basis of the above various embodiments, in one embodiment, the pixel circuit provided by the present embodiment further includes a second initialization module 180. A first terminal of the second initialization module 180 is connected to a third voltage signal line L5, a second terminal of the second initialization module 180 is connected to the control terminal of the driving module 110, a control terminal of the second initialization module 180 is connected to a fifth control signal line to receive a fifth control signal GC5 transmitted on the fifth control signal line, and the second initialization module 180 is configured to transmit a third voltage V3 on the third voltage signal line L5 to the control terminal of the driving module 110 during an initialization phase to initialize a potential of the control terminal of the driving module 110.

In the present embodiment, the scan signal SP is a row-by-row signal, and the first control signal GC1 and the third control signal GC3 are a global signal. That is, in an (n-1)th frame, the first switching units 1201 in pixel circuits of each row are turned on row by row in response to the scan signal SP, to write the data voltage Vdata corresponding to an nth frame row by row. In the nth frame, pixel circuits of all rows are simultaneously turned on in response to the third control signal GC3, and the second switching units 1202 transmit the data voltage Vdata of the nth frame stored on the first node N1 to the first terminal of the coupling module 130. During a light emission phase, the pixel circuits of all rows emit light together across an entire screen in response to the first control signal GC1. Compared with a row-by-row light emission scheme, a full-screen light emission together is beneficial to reducing a flicker problem caused by a dragging of a brightness bar.

The embodiments provided by the present embodiment, by writing the data voltage Vdata of the current frame to the first node N1 row by row during the light emission phase of the previous frame, and writing the data voltage Vdata of the current frame stored on the first node N1 across the entire screen together during the data writing phase of the current frame, can greatly shorten the row time, thereby achieving the high refresh rate display.

In one embodiment, the second control signal GC2, the fourth control signal line GC4, and the fifth control signal line GC5 can also be a global signal.

FIG. 4 is a structural schematic diagram of another pixel circuit provided by an embodiment of the present application. Referring to FIG. 4, the driving module 110 includes a first transistor M1, the compensation module 140 includes a second transistor M2, the light-emitting module 150 includes a light-emitting diode D1, and the light emission control module 160 includes a third transistor M3. A first electrode of the first transistor M1 is connected to the first power supply line L1, a second electrode of the first transistor M1 is connected to a first electrode of the third transistor M3, a second electrode of the third transistor M3 is connected to a first electrode of the light-emitting diode D1, a second electrode of the light-emitting diode D1 is connected to the second power supply line L2, a gate electrode of the third transistor M3 is connected to the first control signal line, a first electrode of the second transistor M2 is connected to the second electrode of the first transistor M1, a second electrode of the second transistor M2 is connected to a gate electrode of the first transistor M1, and a gate electrode of the second transistor M2 is connected to the second control signal line.

The first switching unit 1201 includes a fourth transistor M4, the second switching unit 1202 includes a fifth transistor M5, the first storage unit 1203 includes a first capacitor C1, and the coupling module 130 includes a second capacitor C2. A gate electrode of the fourth transistor M4 is connected to the scan signal line, a first electrode of the fourth transistor M4 is connected to the data line, a second electrode of the fourth transistor M4 is connected to the first node N1, a gate electrode of the fifth transistor M5 is connected to the third control signal line, a first electrode of the fifth transistor M5 is connected to the first node N1, a second electrode of the fifth transistor M5 is connected to a first electrode of the second capacitor C2, a second electrode of the second capacitor C2 is connected to the control terminal of the driving module 110 (i.e., the gate electrode of the first transistor M1), a first electrode of the first capacitor C1 is connected to the first voltage signal line L3, and a second electrode of the first capacitor C1 is connected to the first node N1. The second storage unit 190 includes a third capacitor C3, a first electrode of the third capacitor C3 is connected to the control terminal of the driving module 110, and a second electrode of the third capacitor C3 is connected to the second terminal of the driving module 110.

The first initialization module 170 includes a sixth transistor M6, a first electrode of the sixth transistor M6 is connected to the second voltage signal line L4, a second electrode of the sixth transistor M6 is connected to the first terminal of the coupling module 130 (i.e., the first electrode of the second capacitor C2), and a gate electrode of the sixth transistor M6 is connected to the fourth control signal line.

The second initialization module 180 includes a seventh transistor M7, a first electrode of the seventh transistor M7 is connected to the third voltage signal line, a second electrode of the seventh transistor M7 is connected to the control terminal of the driving module 110, and a gate electrode of the seventh transistor M7 is connected to the fifth control signal line.

In one embodiment, a first electrode of a transistor can be a source electrode, and a second electrode can be a drain electrode; or, the first electrode of the transistor is a drain electrode, and the second electrode is a source electrode.

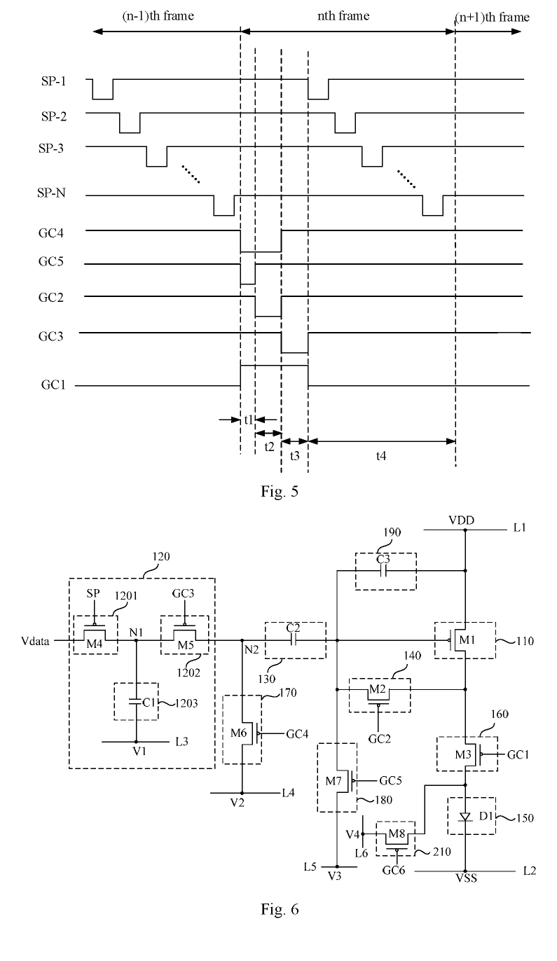

FIG. 5 is a driving timing schematic diagram of a pixel circuit provided by an embodiment of the present application, which is applicable to the pixel circuit shown in FIG. 4. Referring to FIGS. 4 and 5, taking each transistor being a P-type transistor as an example, a specific working process of the pixel circuit provided by the present embodiment includes an initialization phase t1, a compensation phase t2, a data writing phase t3, and a light emission phase t4.

During a light emission phase of an (n-1)th frame, the first transistor M1 drives the light-emitting diode D1 to emit light. At the same time, the fourth transistor M4 is turned on in response to the scan signal SP (SP-1 corresponds to a fourth transistor M4 of a first row pixel circuit, SP-2 corresponds to a fourth transistor M4 of a second row pixel circuit, SP-3 corresponds to a fourth transistor M4 of a third row pixel circuit, and SP-N corresponds to a fourth transistor M4 of an Nth row pixel circuit, where N is an integer greater than or equal to 1), and the data voltage Vdata of the nth frame is written to the first node N1 row by row and stored on the first capacitor C1.

In the nth frame:

In the initialization phase t1, the first control signal GC1 is at a high level, the second control signal GC2 is at a high level, the third control signal GC3 is at a high level, the fourth control signal GC4 is at a low level, the fifth control signal GC5 is at a low level, and the scan signal SP is at a high level. Therefore, the sixth transistor M6 and the seventh transistor M7 are turned on. The second voltage V2 on the second voltage signal line L4 is transmitted to the second node N2 through the sixth transistor M6, to initialize a potential of the first electrode of the second capacitor C2. The third voltage V3 on the third voltage signal line L5 is transmitted to the gate electrode of the first transistor M1 through the seventh transistor M7, to initialize a gate potential of the first transistor M1 and cause the first transistor M1 to be turned on. In one embodiment, the second voltage V2 is not equal to the third voltage V3.

In the compensation phase t2, the first control signal GC1 is at a high level, the second control signal GC2 is at a low level, the third control signal GC3 is at a high level, the fourth control signal GC4 is at a low level, the fifth control signal GC5 is at a high level, and the scan signal SP is at a high level. Therefore, the second transistor M2 and the sixth transistor M6 are turned on. A voltage of the second node N2 is maintained at the second voltage V2. Since the first transistor M1 is in a turned-on state at an end of the initialization phase t1, the first power supply voltage VDD on the first power supply line L1 charges the gate electrode of the first transistor M1 through the first transistor M1 and the second transistor M2 until a gate voltage of the first transistor M1 is VDD+Vth1, and the first transistor M1 is turned off, thereby achieving a threshold voltage compensation of the first transistor M1. In one embodiment, Vth1 is a threshold voltage of the first transistor M1.

In the data writing phase t3, the first control signal GC1 is at a high level, the second control signal GC2 is at a high level, the third control signal GC3 is at a low level, the fourth control signal GC4 is at a high level, the fifth control signal GC5 is at a high level, and the scan signal SP is at a high level. Therefore, the fifth transistor M5 is turned on. The data voltage Vdata of the current frame stored on the first node N1 is transmitted to the second node N2 through the fifth transistor M5, and a voltage at the second node N2 jumps from the second voltage V2 to the data voltage Vdata. Under a coupling effect of the second capacitor C2, the gate voltage of the first transistor M1 becomes VDD+Vth1+a(Vdata-V2), thereby achieving the data writing. In one embodiment, a is a constant, and is related to a capacitance value of the first capacitor C1, the second capacitor C2, and the third capacitor C3.

In the light emission phase, the first control signal GC1 is at a low level, the second control signal GC2 is at a high level, the third control signal GC3 is at a high level, the fourth control signal GC4 is at a high level, and the fifth control signal GC5 is at a high level. Therefore, the third transistor M3 is turned on. The first transistor M1 generates the driving current I according to a voltage of the gate electrode and the first electrode, to drive the light-emitting diode D1 to emit light.

In one embodiment, the driving current I can be expressed as:

In one embodiment, μ is an electron mobility of the first transistor M1, Cox is a channel capacitance per unit area of the first transistor M1, W/L is a width-to-length ratio of the first transistor M1, Vth1 is the threshold voltage of the first transistor M1, and a is a constant related to a capacitance value of the first capacitor C1, the second capacitor C2, and the third capacitor C3.

According to the above formula, the driving current I is related to the data voltage Vdata and a second initialization voltage Vint2, and is not related to a threshold voltage Vth3 of the third transistor M3. The threshold voltage Vth3 of the third transistor M3 does not affect a magnitude of the driving current I. And the driving current I is not affected by the second power supply voltage VSS, so an IR drop of the second power supply voltage VSS can be compensated.

At the same time, in the light emission phase t4, the scan signal SP is at a low level, the fourth transistor M4 is turned on, and a data voltage Vdata of an (n+1)th frame is written to the first node N1 row by row and stored on the first capacitor C1.

In the present embodiment, all row pixel circuits simultaneously perform the initialization phase t1, the compensation phase t2, the data writing phase t3, and the light emission phase t4. In one embodiment, the initialization phase t1, the compensation phase t2, and the data writing phase t3 are all in a blanking phase, a total time of the blanking phase is less than a row time, which can make an initialization degree of the control terminal of the driving module 110 more sufficient and the threshold voltage compensation more sufficient, which is beneficial to improving a display effect.

In another embodiment, the first transistor M1 can be maintained as a P-type transistor, and another transistor can be changed to an N-type transistor. A corresponding driving timing of the N-type transistor has opposite high and low levels to a driving timing of the P-type transistor.

FIG. 6 is a structural schematic diagram of another pixel circuit provided by an embodiment of the present application. Referring to FIG. 6, on a basis of the above various embodiments, in one embodiment, the pixel circuit provided by the present embodiment further includes a third initialization module 210. A first terminal of the third initialization module 210 is connected to a fourth voltage signal line, a second terminal of the third initialization module 210 is connected to the first terminal of the light-emitting module 150, a control terminal of the third initialization module 210 is connected to a sixth control signal line, and the third initialization module 210 is configured to transmit a fourth voltage V4 on a fourth voltage signal line L6 to the first terminal of the light-emitting module 150 during the initialization phase.

In one embodiment, the third initialization module 210 can include an eighth transistor M8. A first electrode of the eighth transistor M8 is connected to the fourth voltage signal line L6, a second electrode of the eighth transistor M8 is connected to the first terminal of the light-emitting module 150, and a gate electrode of the eighth transistor M8 is connected to the sixth control signal line. During the initialization phase, the eighth transistor M8 is turned on in response to a sixth control signal GC6 transmitted on the sixth control signal line, to transmit the fourth voltage V4 to a first electrode of the light-emitting diode D1, to initialize a potential of the first electrode of the light-emitting diode D1, which is beneficial to improving display uniformity.

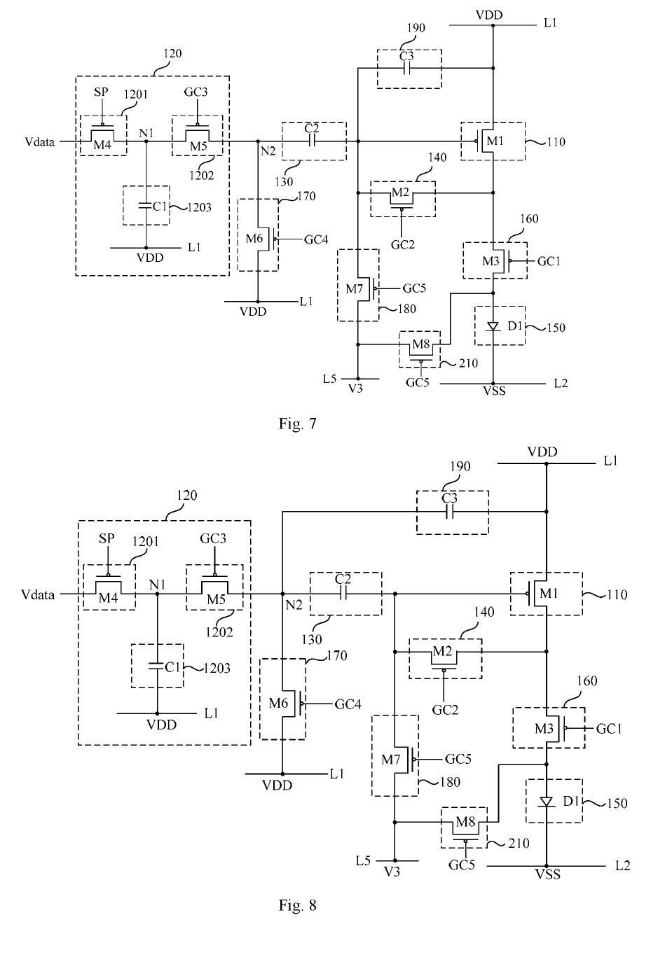

FIG. 7 is a structural schematic diagram of another pixel circuit provided by an embodiment of the present application. Referring to FIG. 6 and FIG. 7, on a basis of the above various embodiments, in one embodiment, the first power supply line L1 can be reused as the first voltage signal line L3 and the second voltage signal line L4, and the first power supply voltage VDD is reused as the first voltage V1 and the second voltage V2. The fifth control signal line is reused as the sixth control signal line, the third voltage signal line L5 is reused as the fourth voltage signal line L6, and the third voltage V3 is reused as the fourth voltage V4. In the present embodiment, the driving timing shown in FIG. 5 is also applicable to the pixel circuit shown in FIG. 7, and a specific working process is not described again.

FIG. 8 is a structural schematic diagram of another pixel circuit provided by an embodiment of the present application. Referring to FIG. 8, the second storage unit 190 can also be connected between the first terminal of the coupling module 130 and the second terminal of the driving module 110. A working process of the pixel circuit shown in FIG. 8 is the same as a working process of the pixel circuit shown in FIG. 4, only a voltage of a partial node is different, a specific working process is not described again herein, and has a same beneficial effect.

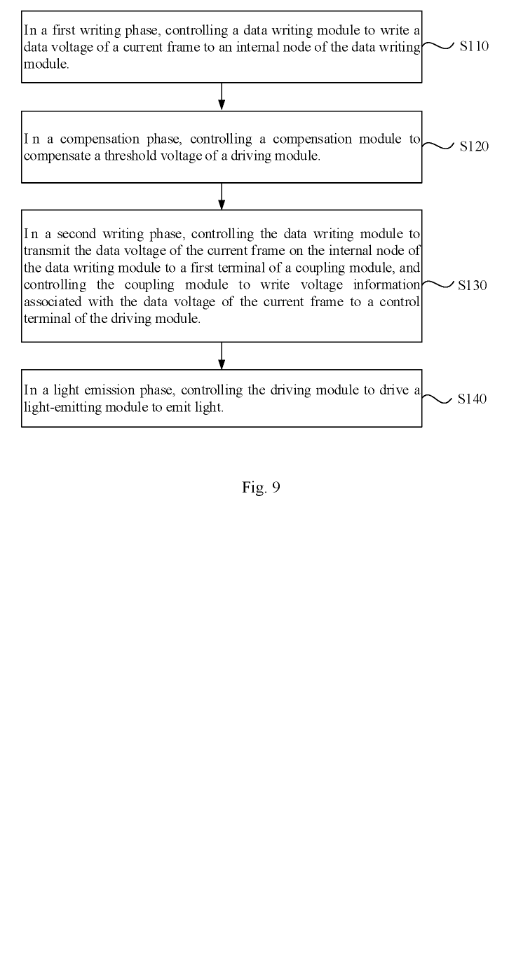

In one embodiment, an embodiment of the present application further provides a driving method for a pixel circuit, for driving the pixel circuit provided by any embodiment of the present application. FIG. 9 is a flowchart of a driving method for a pixel circuit provided by an embodiment of the present application. In combination with FIG. 1 and FIG. 9, the driving method for the pixel circuit provided by the embodiment of the present application includes:

S110, in a first writing phase, controlling a data writing module to write a data voltage of a current frame to an internal node of the data writing module.

S120, in a compensation phase, controlling a compensation module to compensate a threshold voltage of a driving module.

S130, in a second writing phase, controlling the data writing module to transmit the data voltage of the current frame on the internal node of the data writing module to a first terminal of a coupling module, and controlling the coupling module to write voltage information associated with the data voltage of the current frame to a control terminal of the driving module.

S140, in a light emission phase, controlling the driving module to drive a light-emitting module to emit light.

In one embodiment, the first writing phase is a light emission phase of a previous frame, and the second writing phase is a data writing phase of the current frame.

The embodiments provided by the embodiment of the present application, by writing the data voltage Vdata of the current frame to the internal node of the data writing module 120 during the light emission phase of the previous frame, and transmitting the data voltage Vdata of the current frame on the internal node to the first terminal of the coupling module 130 during the data writing phase of the current frame, utilizes the time of the light emission period for the data writing, which is beneficial to reducing the data writing time within one frame, thereby facilitating shortening the row time to achieve the high refresh rate display. In addition, by adopting the coupling method to transmit the data voltage Vdata to the control terminal of the driving module 110, the threshold voltage compensation of the driving module 110 is performed separately from the data writing, and the threshold voltage compensation is performed before writing the data voltage Vdata to the control terminal of the driving module 110, and the compensation phase and the data writing phase do not affect each other, thereby making the time of the threshold voltage compensation unaffected by the data writing phase. Under the high refresh rate, the threshold voltage of the driving module 110 can be completely compensated, thereby reducing the difference in characteristics of the driving modules 110 corresponding to different pixels, which is beneficial to improving the difference in display brightness and enhancing the uniformity of display quality.

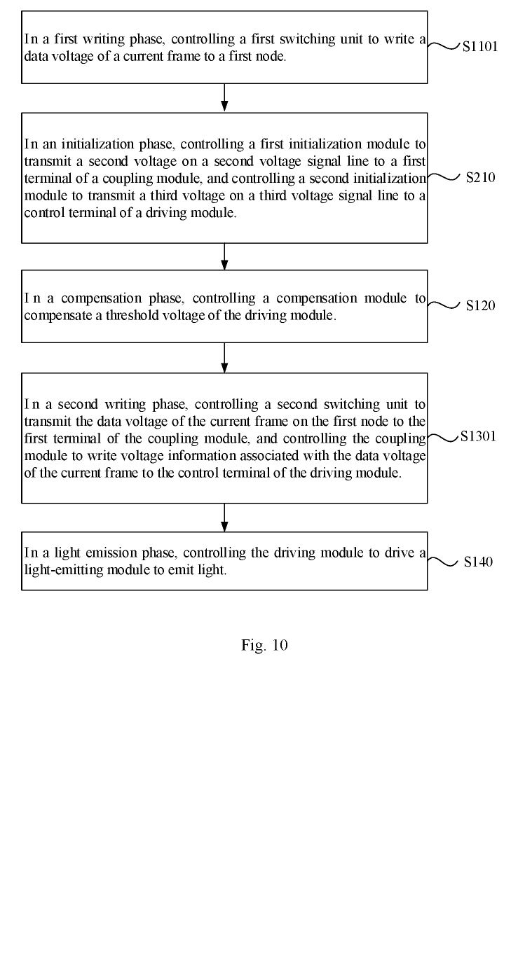

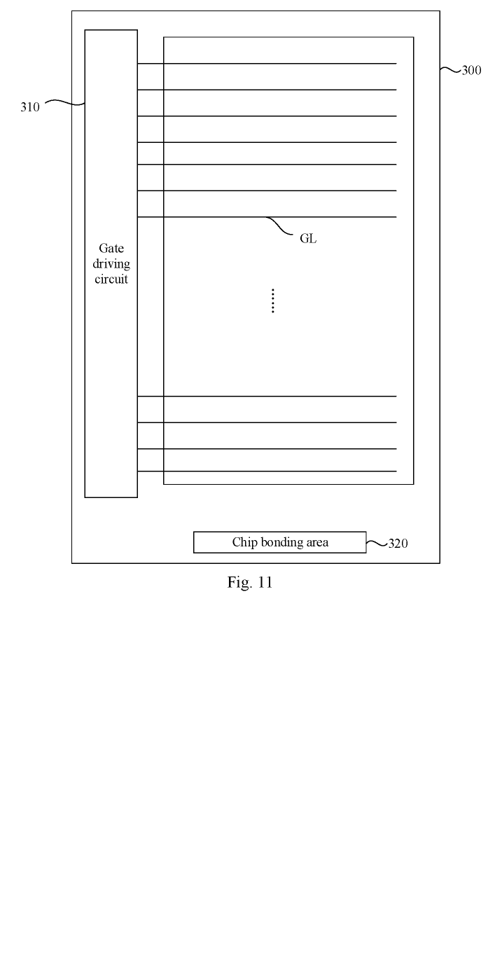

FIG. 10 is a flowchart of another driving method for a pixel circuit provided by an embodiment of the present application. Referring to FIG. 4 and FIG. 10, the driving method for the pixel circuit provided by the present embodiment includes:

S1101, in a first writing phase, controlling a first switching unit to write a data voltage of a current frame to a first node.

S210, in an initialization phase, controlling a first initialization module to transmit a second voltage on a second voltage signal line to a first terminal of a coupling module, and controlling a second initialization module to transmit a third voltage on a third voltage signal line to a control terminal of a driving module.

S120, in a compensation phase, controlling a compensation module to compensate a threshold voltage of the driving module.

S1301, in a second writing phase, controlling a second switching unit to transmit the data voltage of the current frame on the first node to the first terminal of the coupling module, and controlling the coupling module to write voltage information associated with the data voltage of the current frame to the control terminal of the driving module.

S140, in a light emission phase, controlling the driving module to drive a light-emitting module to emit light.

In the initialization phase, controlling the first initialization module 170 and the second initialization module 180 to be turned on, and controlling the first switching unit 1201, the second switching unit 1202, a light emission control module 160, and a compensation module 140 to be turned off.

In the compensation phase, controlling the first initialization module 170 and the compensation module 140 to be turned on, and controlling the second initialization module 180, the first switching unit 1201, the second switching unit 1202, and the light emission control module 160 to be turned off.

In the second writing phase (i.e., a data writing phase), controlling the second switching unit 1202 to be turned on, and controlling the first initialization module 170, the first switching unit 1201, the second initialization module 180, the compensation module 140, and the light emission control module 160 to be turned off.

In the light emission phase, controlling the light emission control module 160 to be turned on, and controlling the first initialization module 170, the compensation module 140, the first switching unit 1201, the second initialization module 180, and the second switching unit 1202 to be turned off.

A specific working principle of the driving method for the pixel circuit provided by the present embodiment can refer to a relevant description of FIG. 4 and FIG. 5 in the above embodiment, which is not described again herein, and has a same beneficial effect.

In one embodiment, an embodiment of the present application further provides a display panel, and the display panel includes the pixel circuit provided by any embodiment of the present application, so the display panel also has a beneficial effect described in any of the above embodiments.

FIG. 11 is a structural schematic diagram of a display panel provided by an embodiment of the present application. Referring to FIGS. 4 and 11, a display panel 300 provided by the present embodiment includes a gate driving circuit 310 and a plurality of scan signal lines GL. The gate driving circuit 310 is connected to the plurality of scan signal lines GL, and the gate driving circuit 310 is configured to output a scan signal SP stage by stage and transmit the scan signal SP to a pixel circuit of a corresponding row through a scan signal line GL. Each scan signal line GL is correspondingly connected to a control terminal of a first switching unit 1201 in one row of pixel circuits.

In one embodiment, the display panel further includes a plurality of first control signal lines, a plurality of second control signal lines, a plurality of third control signal lines, a plurality of fourth control signal lines, and a plurality of fifth control signal lines. The first control signal line is connected to a control terminal of a light emission control module 160, the second control signal line is connected to a control terminal of a compensation module 140, the third control signal line is connected to a control terminal of a second switching unit 1202, the fourth control signal line is connected to a control terminal of a first initialization module 170, and the fifth control signal line is connected to a control terminal of a second initialization module 180. In one embodiment, each row of pixel circuits is respectively connected to one first control signal line, one second control signal line, one third control signal line, one fourth control signal line, and one fifth control signal line. The plurality of first control signal lines are configured to simultaneously transmit a first control signal GC1 to a light emission control module 160 of a pixel circuit of all rows, the plurality of second control signal lines are configured to simultaneously transmit a second control signal GC2 to a compensation module 140 of a pixel circuit of all rows, the plurality of third control signal lines are configured to simultaneously transmit a third control signal GC3 to a second switching unit 1202 of a pixel circuit of all rows, the plurality of fourth control signal lines are configured to simultaneously transmit a fourth control signal GC4 to a first initialization module 170 of a pixel circuit of all rows, and the plurality of fifth control signal lines are configured to simultaneously transmit a fifth control signal GC5 to a second initialization module 180 of a pixel circuit of all rows.

In one embodiment, the display panel provided by the present embodiment further includes a chip bonding area 320, and the chip bonding area 320 is configured to bond a driving chip. The first control signal line, the second control signal line, the third control signal line, the fourth control signal line, and the fifth control signal line are respectively connected to a chip bonding area 320, to provide a corresponding control signal through a driving chip disposed in the chip bonding area 320. Therefore, in the present embodiment, only one set of gate driving circuit 310 is required, which is beneficial to achieving a narrow bezel effect of the display panel 300.

In the present embodiment, the display panel 300 can be applied to a mobile phone, and can also be applied to any electronic product with a display function, including but not limited to the following categories: a television, a notebook computer, a desktop monitor, a tablet computer, a digital camera, a smart bracelet, smart glasses, a vehicle-mounted display, medical equipment, industrial control equipment, a touch interactive terminal, etc. An embodiment of the present application does not make a special limitation on this.

Various forms of a flow shown above can be used, and a step can be reordered, added, or deleted. For example, each step described in the present application can be executed in parallel, can also be executed sequentially, and can also be executed in a different order, as long as a desired result of the embodiments of the present application can be achieved, which is not limited herein.

The above specific embodiment does not constitute a limitation on a protection scope of the present application. A person should understand that, according to a design requirement and another factor, various modifications, combinations, sub-combinations, and substitutions can be made. Any modification, equivalent replacement, and improvement, etc., made within a spirit and principle of the present application should be included within the protection scope of the present application.

What is claimed is:

1. A pixel circuit, comprising: a driving module, a data writing module, a coupling module, a compensation module, and a light-emitting module; wherein
the data writing module is connected to a first terminal of the coupling module, the data writing module is configured to write a data voltage of a current frame into an internal node of the data writing module during a light emission phase of a previous frame, and write the data voltage of the current frame on the internal node to the first terminal of the coupling module during a data writing phase of the current frame;
the coupling module is configured to write a voltage associated with the data voltage of the current frame to the control terminal of the driving module, and a second terminal of the coupling module is connected to a control terminal of the driving module;
the compensation module is connected between a first terminal and the control terminal of the driving module, and the compensation module is configured to compensate a threshold voltage of the driving module during a compensation phase;
the driving module and the light-emitting module are connected between a first power supply line and a second power supply line, and the driving module is configured to drive the light-emitting module to emit light during a light emission phase; and
within one frame, the compensation phase is before the data writing phase.

2. The pixel circuit according to claim 1, further comprising a light emission control module, wherein a first terminal of the light emission control module is connected to the first terminal of the driving module, a second terminal of the light emission control module is connected to a first terminal of the light-emitting module, a second terminal of the light-emitting module is connected to the second power supply line, the first terminal of the driving module is connected to the first power supply line, and a control terminal of the light emission control module is connected to a first control signal line.

3. The pixel circuit according to claim 2, wherein a first power supply voltage transmitted on the first power supply line and a second power supply voltage transmitted on the second power supply line are both a constant voltage.

4. The pixel circuit according to claim 2, wherein the driving module comprises a first transistor, the compensation module comprises a second transistor, the light-emitting module comprises a light-emitting diode, the light emission control module comprises a third transistor, a first electrode of the first transistor is connected to the first power supply line, a second electrode of the first transistor is connected to a first electrode of the third transistor, a second electrode of the third transistor is connected to a first electrode of the light-emitting diode, a second electrode of the light-emitting diode is connected to the second power supply line, a gate electrode of the third transistor is connected to the first control signal line, a first electrode of the second transistor is connected to the second electrode of the first transistor, a second electrode of the second transistor is connected to a gate electrode of the first transistor, and a gate electrode of the second transistor is connected to a second control signal line.

5. The pixel circuit according to claim 1, wherein the data writing module comprises a first switching unit, a second switching unit, and a first storage unit;
a first terminal of the first switching unit is connected to a data line, a second terminal of the first switching unit and a first terminal of the second switching unit are connected to a first node, a second terminal of the second switching unit is connected to the first terminal of the coupling module, a control terminal of the first switching unit is connected to a scan signal line, a control terminal of the second switching unit is connected to a third control signal line, the first switching unit is configured to write the data voltage of the current frame to the first node during the light emission phase of the previous frame, and the second switching unit is configured to write the data voltage of the current frame on the first node to the first terminal of the coupling module;
a first terminal of the first storage unit is connected to a first voltage signal line, and a second terminal of the first storage unit is connected to the first node; and
the internal node comprises the first node.

6. The pixel circuit according to claim 5, wherein the first switching unit comprises a fourth transistor, the second switching unit comprises a fifth transistor, the first storage unit comprises a first capacitor, the coupling module comprises a second capacitor, a gate electrode of the fourth transistor is connected to the scan signal line, a first electrode of the fourth transistor is connected to the data line, a second electrode of the fourth transistor is connected to the first node, a gate electrode of the fifth transistor is connected to the third control signal line, a first electrode of the fifth transistor is connected to the first node, a second electrode of the fifth transistor is connected to a first electrode of the second capacitor, a second electrode of the second capacitor is connected to the control terminal of the driving module, a first electrode of the first capacitor is connected to the first voltage signal line, and a second electrode of the first capacitor is connected to the first node.

7. The pixel circuit according to claim 5, wherein the first power supply line is reused as the first voltage signal line, and a first power supply voltage transmitted on the first power supply line is reused as a first voltage transmitted on the first voltage signal line.

8. The pixel circuit according to claim 1, further comprising a first initialization module, wherein a first terminal of the first initialization module is connected to a second voltage signal line, a second terminal of the first initialization module is connected to the first terminal of the coupling module, a control terminal of the first initialization module is connected to a fourth control signal line, and the first initialization module is configured to transmit a second voltage on the second voltage signal line to the first terminal of the coupling module during an initialization phase and the compensation phase; and
the first initialization module comprises a sixth transistor, a first electrode of the sixth transistor is connected to the second voltage signal line, a second electrode of the sixth transistor is connected to the first terminal of the coupling module, and a gate electrode of the sixth transistor is connected to the fourth control signal line.

9. The pixel circuit according to claim 8, wherein the first power supply line is reused as the second voltage signal line, and a first power supply voltage transmitted on the first power supply line is reused as the second voltage.

10. The pixel circuit according to claim 1, further comprising a second storage unit, wherein the second storage unit is connected between the control terminal and a second terminal of the driving module; and
the second storage unit comprises a third capacitor, a first electrode of the third capacitor is connected to the control terminal of the driving module, and a second electrode of the third capacitor is connected to the second terminal of the driving module.

11. The pixel circuit according to claim 1, further comprising a second storage unit, wherein the second storage unit is connected between the first terminal of the coupling module and a second terminal of the driving module; and
the second storage unit comprises a third capacitor, a first electrode of the third capacitor is connected to the first terminal of the coupling module, and a second electrode of the third capacitor is connected to the second terminal of the driving module.

12. The pixel circuit according to claim 1, further comprising a second initialization module, wherein a first terminal of the second initialization module is connected to a third voltage signal line, a second terminal of the second initialization module is connected to the control terminal of the driving module, a control terminal of the second initialization module is connected to a fifth control signal line, and the second initialization module is configured to transmit a third voltage on the third voltage signal line to the control terminal of the driving module during an initialization phase; and
the second initialization module comprises a seventh transistor, a first electrode of the seventh transistor is connected to the third voltage signal line, a second electrode of the seventh transistor is connected to the control terminal of the driving module, and a gate electrode of the seventh transistor is connected to the fifth control signal line.

13. The pixel circuit according to claim 12, further comprising a third initialization module, wherein a first terminal of the third initialization module is connected to a fourth voltage signal line, a second terminal of the third initialization module is connected to the first terminal of the light-emitting module, a control terminal of the third initialization module is connected to a sixth control signal line, and the third initialization module is configured to transmit a fourth voltage on the fourth voltage signal line to the first terminal of the light-emitting module during the initialization phase; and
the third initialization module comprises an eighth transistor, a first electrode of the eighth transistor is connected to the fourth voltage signal line, a second electrode of the eighth transistor is connected to the first terminal of the light-emitting module, and a gate electrode of the eighth transistor is connected to the sixth control signal line.

14. The pixel circuit according to claim 13, wherein the fifth control signal line is reused as the sixth control signal line.

15. The pixel circuit according to claim 13, wherein the third voltage signal line is reused as the fourth voltage signal line, and the third voltage is reused as the fourth voltage.

16. A driving method for a pixel circuit, wherein the pixel circuit comprises a driving module, a data writing module, a coupling module, a compensation module, and a light-emitting module;
the driving method for the pixel circuit comprises:
in a first writing phase, controlling the data writing module to write a data voltage of a current frame to an internal node of the data writing module;
in a compensation phase, controlling the compensation module to compensate a threshold voltage of the driving module;
in a second writing phase, controlling the data writing module to transmit the data voltage of the current frame on the internal node of the data writing module to a first terminal of the coupling module, and controlling the coupling module to write voltage information associated with the data voltage of the current frame to a control terminal of the driving module;
in a light emission phase, controlling the driving module to drive the light-emitting module to emit light;
wherein the first writing phase is a light emission phase of a previous frame, and the second writing phase is a data writing phase of the current frame.

17. The driving method for the pixel circuit according to claim 16, wherein the pixel circuit further comprises a first initialization module, a second initialization module, and a light emission control module, the first initialization module is connected between a second voltage signal line and the first terminal of the coupling module, the second initialization module is connected between a third voltage signal line and the control terminal of the driving module, and the light emission control module is connected between a first terminal of the driving module and a first terminal of the light-emitting module;
the driving method for the pixel circuit further comprises:
in an initialization phase, controlling the first initialization module to transmit a second voltage on the second voltage signal line to the first terminal of the coupling module, and controlling the second initialization module to transmit a third voltage on the third voltage signal line to the control terminal of the driving module.

18. The driving method for the pixel circuit according to claim 17, wherein one frame sequentially comprises the initialization phase, the compensation phase, the second writing phase, and the light emission phase; and
the data writing module comprises a first switching unit, a second switching unit, and a first storage unit, a first terminal of the first switching unit is connected to a data line, a second terminal of the first switching unit and a first terminal of the second switching unit are connected to a first node, a second terminal of the second switching unit is connected to the first terminal of the coupling module, a first terminal of the first storage unit is connected to a first voltage signal line, and a second terminal of the first storage unit is connected to the first node;
the controlling the data writing module to write the data voltage of the current frame to the internal node of the data writing module in the first writing phase comprises:
in the first writing phase, controlling the first switching unit to write the data voltage of the current frame to the first node;
the controlling the data writing module to transmit the data voltage of the current frame on the internal node of the data writing module to the first terminal of the coupling module in the second writing phase comprises:
in the second writing phase, controlling the second switching unit to transmit the data voltage of the current frame on the first node to the first terminal of the coupling module.

19. The driving method for the pixel circuit according to claim 18, wherein in the initialization phase, controlling the first initialization module and the second initialization module to be turned on, and controlling the first switching unit, the second switching unit, the light emission control module, and the compensation module to be turned off;
in the compensation phase, controlling the first initialization module and the compensation module to be turned on, and controlling the second initialization module, the first switching unit, the second switching unit, and the light emission control module to be turned off;
in the second writing phase, controlling the second switching unit to be turned on, and controlling the first initialization module, the first switching unit, the second initialization module, the compensation module, and the light emission control module to be turned off;
in the light emission phase, controlling the light emission control module to be turned on, and controlling the first initialization module, the compensation module, the first switching unit, the second initialization module, and the second switching unit to be turned off.

20. A display panel, comprising the pixel circuit according to claim 1; wherein
the display panel further comprises a plurality of scan signal lines, a plurality of first control signal lines, a plurality of second control signal lines, a plurality of third control signal lines, a plurality of fourth control signal lines, and a plurality of fifth control signal lines;
the pixel circuit further comprises a first initialization module, a second initialization module, and a light emission control module, the first initialization module is connected between a second voltage signal line and a first terminal of a coupling module, the second initialization module is connected between a third voltage signal line and a control terminal of a driving module, the light emission control module is connected between a first terminal of the driving module and a first terminal of a light-emitting module;
a data writing module comprises a first switching unit, a second switching unit, and a first storage unit, a first terminal of the first switching unit is connected to a data line, a second terminal of the first switching unit and a first terminal of the second switching unit are connected to a first node, a second terminal of the second switching unit is connected to the first terminal of the coupling module, a first terminal of the first storage unit is connected to a first voltage signal line, and a second terminal of the first storage unit is connected to the first node;
wherein each row of the pixel circuits is respectively connected to one of the scan signal lines, one of the first control signal lines, one of the second control signal lines, one of the third control signal lines, one of the fourth control signal lines, and one of the fifth control signal lines, the plurality of scan signal lines are configured to transmit a scan signal to the first switching unit of the pixel circuit row by row, the plurality of first control signal lines are configured to simultaneously transmit a first control signal to the light emission control module of the pixel circuit of all rows, the plurality of second control signal lines are configured to simultaneously transmit a second control signal to a compensation module of the pixel circuit of all rows, the plurality of third control signal lines are configured to simultaneously transmit a third control signal to the second switching unit of the pixel circuit of all rows, the plurality of fourth control signal lines are configured to simultaneously transmit a fourth control signal to the first initialization module of the pixel circuit of all rows, and the plurality of fifth control signal lines are configured to simultaneously transmit a fifth control signal to the second initialization module of the pixel circuit of all rows.
